(19) United States
(12) Patent Application Publication
(10) Pub. No.: US 2015/0259975 A1
(43) Pub. Date: Sep. 17, 2015

(54) Window Covering Device

(71) Applicant: Sherry Helton, Schererville, IN (US)

(72) Inventor: Sherry Helton, Schererville, IN (US)

(21) Appl. No.: 14/554,185

(22) Filed: Nov. 26, 2014

Related U.S. Application Data
(60) Provisional application No. 61/954,053, filed on Mar. 17, 2014.

(51) Int. Cl. E06B 9/24

(52) U.S. Cl. CPC E06B 9/24

(57) ABSTRACT

Disclosed is an apparatus and method for covering a window in a bathroom or shower stall. The apparatus includes a rectangular panel that can be positioned over a window so as to protect the window from water and moisture. Male and female fasteners are provided, wherein each fastener includes an elongated strip having an adhesive backing. The female fasteners can be disposed on the wall surrounding a window in a rectangular configuration. The male fasteners can be secured to the perimeter of a surface of the rectangular panel. The male and female fasteners can then be releasably engaged in order to secure the panel over the window. In this way, the panel can be used to removably cover the window in the shower stall or bathroom to prevent the window from exposure to moisture.

### CROSS REFERENCE TO RELATED APPLICATION

This application claims the benefit of U.S. Provisional Application No. 61/954,053 filed on Mar. 17, 2014. The above identified patent application is herein incorporated by reference in its entirety to provide continuity of disclosure.

### BACKGROUND OF THE INVENTION

1. Field of the Invention

The present invention relates to a window covering device. More specifically, the present invention provides a transparent panel that can be removably positioned over a window in a bathroom or shower stall so as to protect the window from exposure to water and moisture to prevent damage to the window and window frame. Female fasteners are positioned about the perimeter of the window, and the panel includes male fasteners adapted to engage with the female fasteners disposed around the window in order to secure the panel thereto.

Bathrooms and shower stalls often have one or more windows in order to provide ventilation to the bathroom or shower stall. Further, windows allow natural light to enter the bathroom in order to reduce the need for other light sources, such as overhead lighting or lamps. However, the bathroom windows are exposed to water and moisture from the shower or bathtub. As a result, the window can develop hard water stains, which can be unsightly and difficult to remove. Further, a wooden window frame may begin to rot and a metal window frame may rust from exposure to water and moisture. Additionally, mildew may develop around the window. Thus, a device that can protect a bathroom window from damage resulting from exposure to water and moisture is desired.

The present invention provides a window covering device adapted for use in bathrooms. The device includes a rectangular panel that is preferably transparent. The panel is adapted to be placed over a window and window frame so as to shield the same from exposure to water or moisture within the bathroom. Female fasteners are disposed on the wall about the perimeter of the window frame and include elongated strips. The female fasteners include channels on a front surface thereof and an adhesive on the rear surface for securement to the wall. Male fasteners comprise elongated strips adapted to be positioned about the perimeter of a surface of the panel and are positioned so as to align with the female fasteners on the wall around the window. The male fasteners also include an adhesive backing for securing the male fasteners to the panel. The male and female fasteners can be engaged to removably secure the panel to the window in order to protect the window from exposure to moisture.

2. Description of the Prior Art

Devices have been disclosed in the prior art that relate to shower and bathtub covering devices. These include devices that have been patented and published in patent application publications. These devices generally relate to liners for bathtubs and shower stalls. The following is a list of devices deemed most relevant to the present disclosure, which are herein described for the purposes of highlighting and differentiating the unique aspects of the present invention, and further highlighting the drawbacks existing in the prior art.

One such device, U.S. Patent Application Publication Number 2009/0300837 to Ellzey discloses a protective shield for a shower or tub. The device can be removably attached to the walls of the shower to protect the walls from exposure to water. The panel includes attachment members, such as suction cups, for securing the panel to a wall. Thus, Ellzey does not disclose a flexible, transparent panel adapted to be positioned over a window in a bathroom to shield the window from exposure to water or moisture.

U.S. Pat. No. 3,938,200 to Roberts et al. discloses a bathtub liner. The device includes a sheet of flexible, plastic film having openings along the edges thereof in order to hang the liner on hooks on the walls of a bathtub. The bathtub liner can be draped over the front of the tub. Roberts et al. does not disclose a device for protecting a window in a bathroom from exposure to moisture, and does not disclose a flexible rectangular panel for covering a window.

U.S. Pat. No. 5,435,021 to Williams discloses a shower wall liner. The shower wall liner can be removably placed on the walls of a tub or shower stall. The liner includes an elastic film supported by a structurally rigid framework including L-shaped bottom members and corner members. Williams fails to disclose a rectangular panel adapted to be positioned over a window to protect the window from moisture and water damage.

Finally, U.S. Design Patent Number D496,449 to Adams discloses the ornamental design for a splash guard for a bathtub and shower, wherein the shower guard is adapted to prevent water from escaping the bathtub and shower. The splash guard comprises a triangular shape wherein one side of the triangle is rounded. The area of the triangle includes a pattern or design thereon. Thus, Adams discloses a splash guard for a bathtub, and does not disclose a window covering device for use in a bathroom.

These prior art devices have several known drawbacks. Several devices in the prior art relate to shower wall or bathtub covering devices. Such devices are adapted to protect the shower walls or bathtub from exposure to water to prevent hard water stains and other build-up thereon. However, these devices are not specifically adapted to cover a window in a bathroom to shield the window from water. Further, the devices in the prior art do not disclose the use of a flexible, rectangular panel to be secured over a window and window frame using male and female fasteners.

In light of the devices disclosed in the prior art, it is submitted that the present invention substantially diverges in design elements from the prior art and consequently it is clear that there is a need in the art for an improvement to existing window covering devices. In this regard the instant invention substantially fulfills these needs.

### SUMMARY OF THE INVENTION

In view of the foregoing disadvantages inherent in the known types of window covering devices now present in the prior art, the present invention provides a new window covering device wherein the same can be utilized for providing convenience for the user when protecting a bathroom window from exposure to water or moisture.

It is therefore an object of the present invention to provide a new and improved window covering device that has all of the advantages of the prior art and none of the disadvantages.

It is another object of the present invention to provide a window covering device that protects a bathroom window from exposure to moisture or water within the bathroom by covering the window with a flexible, rectangular panel.

Another object of the present invention is to provide a window covering device that can be removably positioned over a window by engaging male and female fasteners positioned on the window covering and on the wall surrounding the window, respectively.

Yet another object of the present invention is to provide a window covering device that is transparent and does not inhibit light from entering into a room through the window.

Another object of the present invention is to provide a window covering device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the window covering device of the present invention as installed on a window.

FIG. 2A shows a perspective view of the window covering device of the present invention as positioned for installation.

FIG. 2B shows a close-up view of the fasteners of the present invention.

### DETAILED DESCRIPTION OF THE INVENTION

Reference is made herein to the attached drawings. Like reference numerals are used throughout the drawings to depict like or similar elements of the window covering device. For the purposes of presenting a brief and clear description of the present invention, the preferred embodiment will be discussed as used for shielding a window from moisture and water within a bathroom. The figures are intended for representative purposes only and should not be considered to be limiting in any respect.

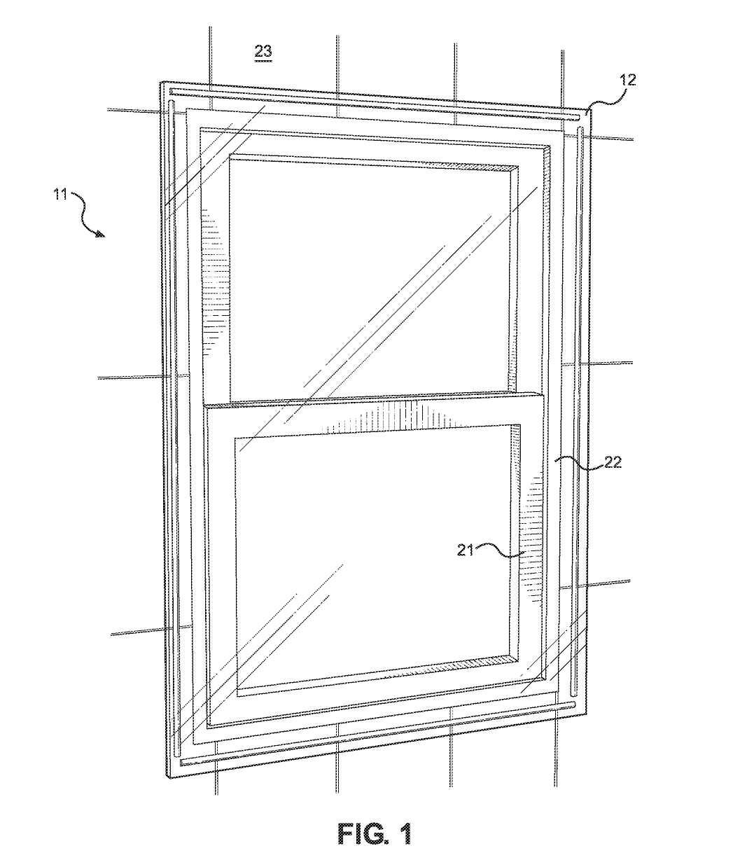

Referring now to FIG. 1, there is shown a perspective view of the window covering device of the present invention as installed on a window. The window covering device 11 of the present invention comprises a flexible, rectangular panel 12 adapted to be disposed over a window 21 and window frame 22. The panel 12 is transparent so that the panel 12 allows light to pass therethrough. The panel 12 is composed of a material that is waterproof and that resists the formation of mildew or mold thereon. Further, the panel 12 is preferably lightweight so that it can be easily installed and will remain in position over the window 21. Thus, the panel 12 may be composed of clear vinyl or other similar material.

The panel 12 may be cut by the user so that the panel 12 is sufficient in size to cover the window and extend partially onto the wall surrounding the window. The panel 12 is secured to the wall surrounding the window and window frame using male and female mating fasteners. In this way, the panel 12 can cover and protect the window and window frame so that the window and window frame are not damaged by prolonged exposure to water and moisture. The panel 12 physically prevents water and moisture from contacting the window.

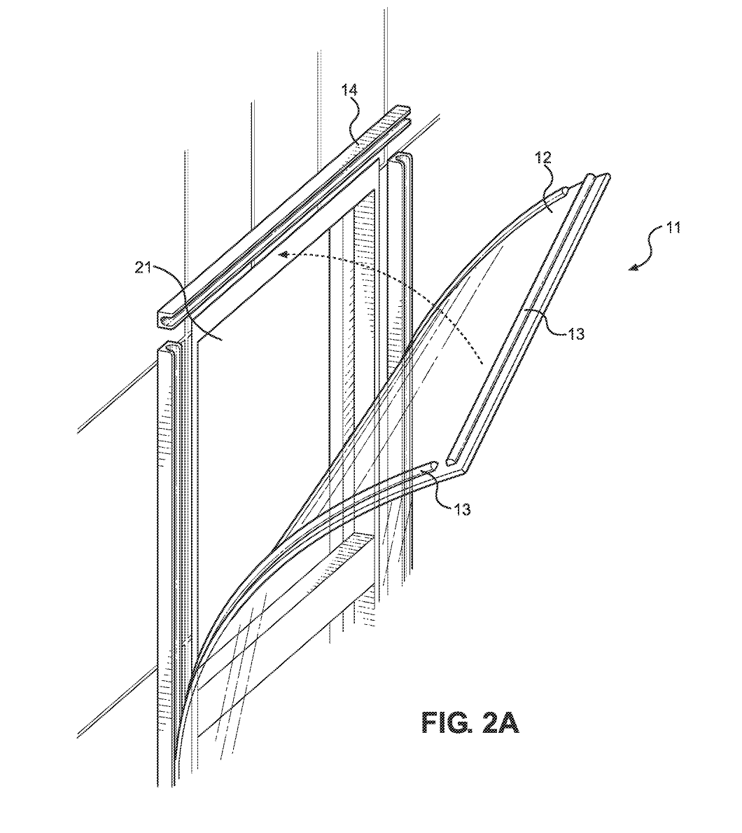

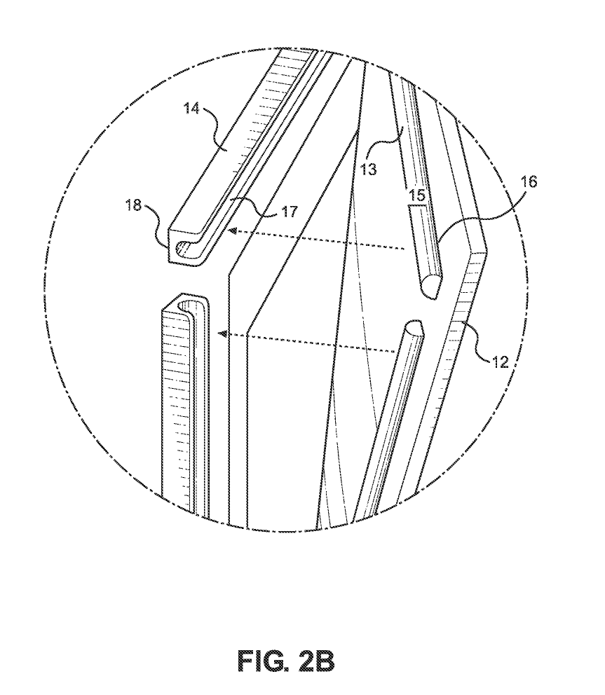

Referring now to FIGS. 2A and 2B, there are shown perspective views of the window cover of the present invention as positioned for installation. The panel 12 can be removably secured over a window 21 by means of male fasteners 13 and female fasteners 14. The male fasteners 13 comprise elongated strips having a front surface 15 and a rear surface 16. The rear surface 16 includes an adhesive thereon. The adhesive may be protected by a removable backing until the time the male fastener 13 is desire to be used. The front surface 15 includes a protrusion that extends along the length of the elongated strip and that is adapted to removably engage with the female fastener 14.

The female fastener 14 also comprises elongated strips having a front surface 17 and a rear surface 18. The rear surface 18 includes an adhesive thereon. The adhesive may be protected by a removable backing until the female fastener 14 is desired to be used. The front surface 17 of the female fastener 14 includes a channel that extends along the length of the elongated strip. The channel is adapted to receive the protrusion of the male fastener 13. The male and female fasteners 13, 14 can be removably secured together via a press fit.

In operation, the removable backing can be removed from the female fasteners 14, and the rear surface 18 of the female fasteners 14 can be positioned on the wall surrounding a window and window frame. Thus, the female fasteners 14 are arranged in a rectangular configuration about the perimeter of the window 21. Similarly, the removable backing of the male fasteners 13 can be removed, and the rear surface 16 of each male fastener 13 can be secured to a surface of the rectangular panel 12 about the perimeter thereof. The male fasteners 13 are arranged in a rectangular configuration and are positioned so as to align with the female fasteners 14 on the wall around the window 21. The panel 12 can then be secured over the window 21 and window frame by aligning and securing the male fasteners 13 thereon to the female fasteners 14 on the wall surrounding the window 21. No tools or other fasteners are required, and the panel can be easily installed and removed as desired by the user.

The male and female fasteners 13, 14 may be adapted to provide a substantially water tight seal between the panel 12 and the wall around the window. In this way, water and moisture is prevented from contacting the window or window frame. The male and female fasteners 13, 14 are preferably disposed around the entire perimeter of the window so that when the male fasteners 13 are engaged with the female fasteners 14, a seal is formed substantially about the entire perimeter of the panel 12. In some embodiments of the present invention, the male fasteners 13 are permanently affixed to a surface of the panel 12.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A window covering device, comprising:
a transparent, rectangular panel adapted to be positioned over a window;
a plurality of male fasteners comprising elongated strips having a front surface and a rear surface, wherein said rear surface includes an adhesive thereon and wherein said front surface includes a protrusion;
a plurality of female fasteners comprising elongated strips having a front surface and a rear surface, wherein said rear surface includes an adhesive thereon and wherein said front surface includes a channel;
wherein said plurality of male fasteners are adapted to be secured to said rectangular panel, and wherein said plurality of female fasteners are adapted to be secured to a wall surrounding said window, and wherein said plurality of male fasteners and said plurality of female fasteners can be removably engaged.

2. The window covering device of claim 1, wherein said rectangular panel is flexible.

3. The window covering device of claim 1, wherein said rear surface of said plurality of female fasteners and said rear surface of said plurality of male fasteners includes a removable backing thereon.

4. The window covering device of claim 1, wherein said channel of said plurality of female fasteners is configured to receive said protrusion of said plurality of male fasteners therein.

5. A method for covering a window comprising the steps of:
securing a plurality of female fasteners to a wall about the perimeter of a window;
securing a plurality of male fasteners about the perimeter of a transparent, rectangular panel;
engaging said plurality of female fasteners with said plurality of male fasteners so as to secure said rectangular panel over said window.

6. The method of claim 5, wherein said plurality of female fasteners comprises elongated strips having a rear surface and a front surface, wherein said rear surface comprises an adhesive thereon, and wherein said front surface comprises a channel thereon.

7. The method of claim 5, wherein said plurality of male fasteners comprises elongated strips having a rear surface and a front surface, wherein said rear surface comprises an adhesive thereon, and wherein said front surface comprises a protrusion thereon.
